(19) United States
(12) Patent Application Publication
(10) Pub. No.: US 2020/0103014 A1
(43) Pub. Date: Apr. 2, 2020

(54) PULLEY NUT AND A PULLEY SYSTEM INCLUDING THE PULLEY NUT

(71) Applicant: PSM IP Limited, Tortola (VG)

(72) Inventor: Bob MANGAPORA, Canfield, OH (US)

(21) Appl. No.: 16/589,454

(22) Filed: Oct. 1, 2019

Related U.S. Application Data
(60) Provisional application No. 62/740,196, filed on Oct. 2, 2018.

(51) Int. Cl. F16H 57/00; F16H 55/36; F16B 37/04

(52) U.S. Cl. CPC F16H 57/0031; F16H 55/48; F16B 37/045; F16H 55/36

(57) ABSTRACT

A pulley nut and a pulley system that includes the pulley nut and a pulley wheel rotatably mountable or mounted on the pulley nut, the pulley nut including a head, a first shank extending from the head in a longitudinal direction, the head having at least a portion that extends radially away from the first shank, a second shank extending from the first shank in the longitudinal direction, the second shank having a base and an end opposite the base, a shoulder at the base of the second shank having at least a portion that extends radially from the base of the second shank, and a bore defined in the second shank and extending from the end of the second shank into the second shank.

### CROSS-REFERENCE TO RELATED APPLICATION

The present application claims priority to U.S. Provisional Application Ser. No. 62/740,196, filed Oct. 2, 2018, the entire disclosure of which is incorporated by reference herein.

### FIELD OF THE INVENTION

The present invention relates to a pulley nut configured to be fixedly installed in an opening through a plate or other support for the pulley, and the nut is configured for attaching the pulley to the plate using a cold forming process.

### BACKGROUND

Pulley systems are known.

A typical pulley system includes a pulley wheel that is rotatably mounted on a shaft or a shank.

U.S. Pat. No. 6,607,339 discloses a pulley system mountable on a plate. The pulley system includes a stud, and a pulley wheel that is rotatably mountable on the stud. The stud includes a head having an enlarged diameter relative to a shank that extends from the head. Once installed, the pulley wheel is held captive between the plate and the head of the stud. The shank is cylindrical and has a first portion constituting a stub shaft for the pulley wheel. The end of the first portion of the shank is connected to a smaller diameter shank portion. A threaded shaft is located at the end of the smaller diameter shank portion and extends away from the head to a terminal end. The shaft and the smaller diameter shank portion are integrated to form a unitary body. The shaft has a fixed length and is oriented to extend into the plate upon installation of the stud.

### SUMMARY OF THE INVENTION

The present invention is concerned with a pulley nut that can rotatably support a pulley wheel and can be mounted to a plate through cold forming.

The present invention is further concerned with a pulley system that includes the pulley nut and a pulley wheel rotatably mountable on the pulley nut.

A pulley nut according to the present invention includes a head, a first shank extending from the head in a longitudinal direction, the head having at least a portion that extends radially away from the first shank, a second shank extending from the first shank in the longitudinal direction, the second shank having a base and an end opposite the base, a shoulder at the base of the second shank having at least a portion that extends radially from the base of the second shank, and a bore defined in the second shank and extending from the end of the second shank into the second shank.

To install the pulley nut on a plate, the second shaft of the pulley nut is passed through the plate, and the portion of the second shaft that passes through the plate is flared (through cold forming, for example) to secure the pulley nut to the plate.

Unlike the prior art pulley stud discussed in the background, a pulley nut according to the present invention does not have a fixed-length shaft extending from the portion that is passed through the plate (i.e. the second shank). Thus, a pulley nut according to the present invention requires less space for installation.

The first shank and the second shank may be cylindrical bodies each having an outer diameter, the outer diameter of the first shank may be larger than the outer diameter of the second shank, and the shoulder may be an annular surface around the base of the second shank.

The first shank may have a base at the head and the head is annular with an outer diameter larger than the outer diameter of the first shank.

The bore may extend through the first shank and the second shank, and the head may have a through opening that is adjacent and connected to the bore.

The through opening in the head may be frustoconical.

The bore may be threaded to receive a threaded bolt for additional support.

The first shank, the second shank and the head may be co-axial.

The bore in the second shaft may define a shaft wall that has a first thickness at the end of the second shaft, and thickens from the end of the second shaft along the bore toward the base of the second shaft.

The pulley nut may further include splines defined in the shoulder around the second shank.

The pulley nut may further include splines defined on an exterior wall of the second shank adjacent the base of the second shank.

A pulley system according to the present invention includes a pulley wheel rotatably mountable on the first shank of a pulley nut according to the present invention.

### BRIEF DESCRIPTION OF THE DRAWINGS

FIG. 1 shows an elevational view of a pulley nut according to the invention;

FIG. 2 shows an elevational cross-section thereof;

FIG. 3 shows another embodiment of the pulley nut installed in a stationary plate and the nut supporting a pulley for rotation around the nut;

FIG. 4 is an elevational cross-section view of a pulley nut installed to a rail or bracket assembly;

FIG. 5 is an assembly on a rail of two of the pulley nuts in a rail assembly;

FIG. 6 is a top view of the assembly.

### DESCRIPTION OF THE INVENTION

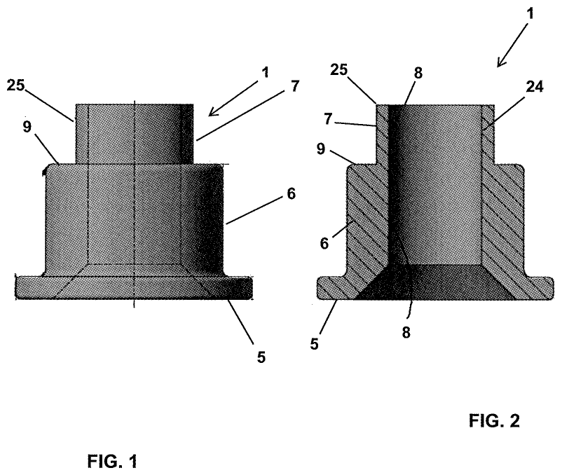

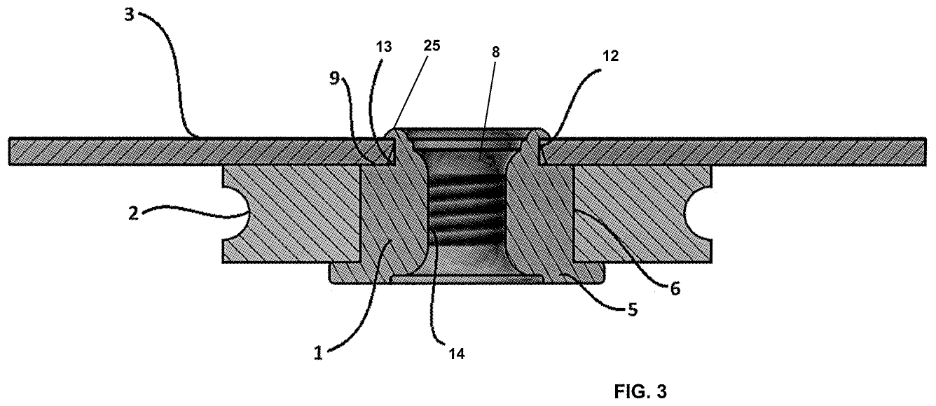

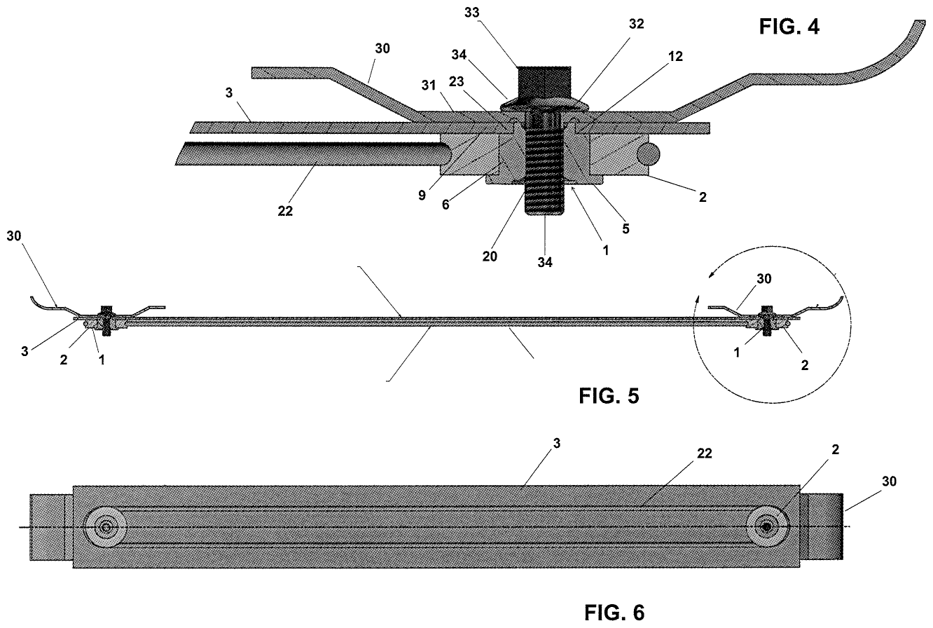

With reference to FIGS. 1-4, a pulley nut 1 is configured for mounting a rotatable pulley 2 to a stationary plate 3 (FIG. 3) or bracket 30 (FIG. 4) by a cold forming process

The nut 1 has a cylindrical wider diameter, cylindrical main shank 6 toward its bottom end. (Nut orientation depends on where it is installed, so top and bottom are named in this disclosed orientation.) The shank 6 acts as a stub shaft for the pulley 2 which is rotatable around the stub shaft. The nut has a head 5 below the shank 6 of a larger diameter than the diameter of the shank 6. The head 5 at the end of the shank 6 retains the pulley 2 on the shank 6 and immediately below the plate 3, so that the pulley is held in place and not removed axially past the head 5.

Above the wider diameter shank 6, there is a narrower diameter shank 7 which extends up from the shank 6. Both shanks are annular.

The annular shank 7 is thinner in thickness than is the annular shank 6. The optionally gradually widened upper region 24 of the bore 8 in the shank 7 (FIG. 3) enables the upper part 25 of the shank 7 to be folded down to the plate 3 in a cold forming process. The bore 8 in FIG. 2 is not widened.

A shoulder 9 extends radially and joins the top end of the wider diameter shank 6 and the bottom end of the narrower diameter shank 7. The shoulder 9 defines an annular support surface for a plate 3 to which the nut 1 is to be attached. The plate 3 has an opening 12 through it, sized at least approximately to the outer diameter of the narrower shank 7 before cold forming.

Optionally, in FIG. 3, there are upraised splines 13, at least on the surface of the shoulder 9 and additionally, optionally on or extending from the shoulder 9 and up onto the periphery of the narrow shank 7. The splines may be ribs, flat facets or splines on the shoulder and/or on the peripheral surface of the narrow shank 7, against which the plate is cold formed.

In FIG. 3, the nut 1 has a central bore with a threaded passage opening 14 from the wider diameter head 5 to the narrow diameter shank 7.

In FIG. 4, a threaded bolt 20 is installed through the top of the nut to mate with the threads in the opening 14 in the shank 6. Tightening the bolt into the threads in the shank secures the nut 1 to the bolt 20. In FIGS. 3 and 4, the bolt 20 and its head 33 attaches the plate 3 to the bent over top end 25 of the shank 6 and attaches a bracket 30 to the plate 3 as in FIG. 4.

The pulley 2 is rotatable around the shank 6 serving as a stub shaft. The pulley is for example fabricated of a plastic, such as a nylon material. The rotating pulley 2 slides past the plate 3 and generally does not generate excessive heat, whereby surface wear between the pulley and the plate is usually not a problem. In a preferable design, there may be a slight gap between the pulley and the side of the plate facing the pulley, which also eases rotation. The pulley 2 supports a cable 22 for rotation around the pulley as the pulley rotates.

In FIGS. 3 and 4, the nut 1 is to be fastened to the plate 3. The opening 12 in the plate 3 is placed over the narrower upstanding shank 7. The annular area 23 of the plate around the opening 12 seats on the shoulder 9 of the nut.

The upstanding narrow shank 7 is then cold formed and its top end part 25 is pressed downward onto the top side of the plate 3, spaced away from the shank 6 and above the shoulder 9. The cold forming may be conventionally done via a tool (not shown) inserted into the opening 8 into the narrower shank 7. The tool is applied there to deform the upper part 24, 25 of the narrower shank outwardly and downwardly toward the plate 3, eventually causing the surface of the previously end 25 upper surface 24 of the shank 7 to be pressed against the exposed annular surface portion 23 of the plate 3 around the opening 12 in the plate.

This cold-forming process also presses the plate 3 down on the splines 13 on the surface of the shoulder 9 and optionally against the optional splines on the surface of the narrow shank 7, which splines are on the shoulder and inside the opening 12 in the plate. The splines are harder and less malleable than is the annular area 23 of the metal plate around the opening 12, so that the surface of the plate 3 facing the shoulder 9 deforms slightly as each spline 13 on the shoulder creates and then enters a deformation or recess (not shown) formed in the plate. Each recess or deformation locks the nut 1 against rotating with respect to the stationary plate 3, while the pulley 2 may rotate on the shank 6.

FIG. 3 shows a pulley nut 1 embodiment as seen in FIG. 3 mounted on a plate 3. That assembly is in turn shown in FIGS. 4-6 installed on a bracket 30, which bracket may be attached elsewhere as needed. FIGS. 4-6 show this in one example installation of an assembly operable for rotation to raise or lower a vehicle window.

The bracket 30 has a portion 31 that is laid on the top side of the plate 3. The bracket has a hole 32 through it that is aligned with the hole 12 through the plate 3 and the bore 8, 14 of the nut.

The installation shown in FIG. 5 shows pulley nuts 1, as in FIG. 4, at each end of a long plate 3. The circled detail in FIG. 5 is in FIG. 4.

An alternative embodiment of the pulley nut in FIG. 3 is shown in FIGS. 1 and 2 and includes the invention. That nut has the elements of the embodiment of FIG. 3, except the bore 14 is not threaded and splines as in FIGS. 3 and 4 are not illustrated. Instead, a bolt (not shown) may be inserted through either end of the pulley nut 1 and out of the top edge 8 into a separate component (not shown), like a vehicle component located where the plate 3 or bracket 30 are shown located in FIGS. 3 and 4.

Alternatively, a bolt 20 may be inserted into the nut with the bolt head 33 at the plate 3 at the bracket 31. The bolt 20 will be threaded on its exterior 34 if it is to be screwed into the threads in the bore 14 of the nut. The bolt 20 has a head 33, 34 which presses down on the outer surface of the bracket 30 and therefore presses down on the plate 3 to press down on the folded down shank part 24 and the annular end area 23 of the plate 3 firmly against the plate 3.

In all arrangements, pressure on the shoulder 9 deforms the plate area 23, which then together with the shoulder and its optional splines prevent rotation of the pulley nut 1 around the shank 6 with respect to the plate 3.

What is claimed is:

1. A pulley nut, comprising:
a head;
a first shank extending from said head in a longitudinal direction, said head having at least a portion that extends radially away from said first shank;
a second shank extending from said first shank in the longitudinal direction, said second shank having a base and an end opposite said base;
a shoulder at said base of said second shank having at least a portion that extends radially from said base of said second shank; and
a bore defined in said second shank and extending from said end of said second shank into said second shank.

2. A pulley nut according to claim 1, wherein said first shank and said second shank are cylindrical bodies each having an outer diameter, and said outer diameter of said first shank is larger than said outer diameter of said second shank, and wherein said shoulder comprises an annular surface around said base of said second shank.

3. A pulley nut according to claim 2, wherein said first shank has a base at said head and said head is annular with an outer diameter larger than said outer diameter of said first shank.

4. A pulley nut according to claim 3, wherein said bore extends through said first shank and said second shank, and wherein said head has a through opening that is adjacent and connected to said bore.

5. A pulley nut according to claim 4, wherein said through opening in said head is frustoconical.

6. A pulley nut according to claim 4, wherein said bore is threaded.

7. A pulley nut according to claim 3, wherein said first shank, said second shank and said head are co-axial.

8. A pulley nut according to claim 1, wherein said bore in said second shank defines a shaft wall that has a thickness at the end of the second shank that thickens from said end of said second shank along said bore toward said base of said second shank.

9. A pulley nut according to claim 1, further comprising splines defined in said shoulder around said second shank.

10. A pulley nut according to claim 1, further comprising splines defined in said shoulder around said second shank and splines defined on an exterior wall of said second shank adjacent said base of said second shank.

11. A pulley system, comprising:
a pulley wheel; and a pulley shaft that includes a head; a first shank extending from said head in a longitudinal direction, said head having at least a portion that extends radially away from said first shank; a second shank extending from said first shank in the longitudinal direction, said second shank having a base and an end opposite said base; a shoulder at said base of said second shank having at least a portion that extends radially from said base of said second shank; and a bore defined in said second shank and extending from said end of said second shank into said second shank,
wherein said pulley wheel is rotatably mountable around said first shank.

12. A pulley system according to claim 11, wherein said first shank and said second shank are cylindrical bodies each having an outer diameter, and said outer diameter of said first shank is larger than said outer diameter of said second shank, and wherein said shoulder comprises an annular surface around said base of said second shank.

13. A pulley system according to claim 12, wherein said first shank has a base at said head and said head is annular with an outer diameter larger than said outer diameter of said first shank.

14. A pulley system according to claim 13, wherein said bore extends through said first shank and said second shank, and wherein said head has a through opening that is adjacent and connected to said bore.

15. A pulley system according to claim 14, wherein said through opening in said head is frustoconical.

16. A pulley system according to claim 14, wherein said bore is threaded.

17. A pulley system according to claim 13, wherein said first shank, said second shank and said head are co-axial.

18. A pulley system according to claim 11, wherein said bore in said second shank defines a shaft wall that has a thickness at the end of the second shaft and thickens from said end of said second shank along said bore toward said base of said second shank.

19. A pulley system according to claim 11, further comprising splines defined in said shoulder around said second shank.

20. A pulley system according to claim 11, further comprising splines defined in said shoulder around said second shank and splines defined on an exterior wall of said second shank adjacent said base of said second shank.
